(19) United States
(12) Patent Application Publication
(10) Pub. No.: US 2009/0055254 A1
(43) Pub. Date: Feb. 26, 2009

(54) DYNAMIC AND INTERACTIVE ADVERTISEMENTS

(75) Inventors: Anand Madhavan, Milpitas, CA (US); Shyam Kapur, Sunnyvale, CA (US)

Correspondence Address: BRINKS HOFER GILSON & LIONE / YAHOO! OVERTURE, P.O. BOX 10395, CHICAGO, IL, 60610, US

(73) Assignee: YAHOO! INC., Sunnyvale, CA (US)

(21) Appl. No.: 11/843,898

(22) Filed: Aug. 23, 2007

(51) Int. Cl. G06Q 30/00

(52) U.S. Cl. 705/14

(57) ABSTRACT

A system and method are disclosed for dynamic advertisement (ad) presentation. Dynamic ads may be presented on a page in a variety of different forms with different features based on dynamic ad factors. The dynamic ad may include a number of different ad components depending on the dynamic ad factors. The dynamic ad factors may include any considerations relevant to the presentation of an ad. The presentation of the ad may include an interactive component that receives user input.

### BACKGROUND

Online advertising may be an important source of revenue for enterprises engaged in electronic commerce. A number of different types of web page based online advertisements are currently in use, along with various associated distribution requirements, advertising metrics, and pricing mechanisms. Processes associated with technologies such as Hypertext Markup Language (HTML) and Hypertext Transfer Protocol (HTTP) enable a web page to be configured to contain a location for inclusion of an advertisement. A page may not only be a web page, but any other electronically created page or document. An advertisement can be selected for display each time the page is requested, for example, by a browser or server application.

Online advertisements may be targeted to users based on available information. For example, online advertising may be linked to online searching. Online searching is a common way for consumers to locate information, goods, or services on the Internet. The advertising that is shown on the search engine page may be related to the search term. Alternatively, advertisements may be targeted based on the content of a page. In one example, CONTENT MATCH® (sold by Yahoo!, Inc., Sunnyvale, Calif.) may select the advertisements that are displayed based with the content of the page.

It is helpful to increase the effectiveness of online advertisements for advertisers. The effectiveness may be determined based on a user interaction with the advertisement or based on the number times the advertisement is viewed. Although advertisements may be targeted, improvements in the personalization and presentation of advertisements may also increase their effectiveness.

### BRIEF DESCRIPTION OF THE DRAWINGS

The system and/or method may be better understood with reference to the following drawings and description. Non-limiting and non-exhaustive embodiments are described with reference to the following drawings. The components in the figures are not necessarily to scale, emphasis instead being placed upon illustrating the principles of the invention. In the figures, like referenced numerals designate corresponding parts throughout the different views.

FIG. 1 is a block diagram illustrating one embodiment of an exemplary advertising system;

FIG. 2 is a flow chart illustrating one embodiment of advertisement presentation;

FIG. 3 is a diagram illustrating an exemplary embodiment of an advertising system using dynamic advertisements;

FIG. 4 illustrates an example of an advertisement;

FIG. 5 is a flow chart illustrating an interaction with an advertisement;

FIG. 6 is a diagram illustrating a further interaction with an advertisement; and

FIG. 7 is an illustration of a general computer system for use with the disclosed embodiments.

### DETAILED DESCRIPTION

The principles described herein may be embodied in many different forms. By way of introduction, the disclosed embodiments relate to a system and method for advertising and, in particular, to dynamic advertisement presentation. Dynamic advertisements may include advertisements that may be presented in different forms, with the presentation of the advertisement being dynamically selected upon request. Dynamic advertisements may be presented on a page in a variety of different forms with different features based on dynamic advertisement factors. The dynamic advertisement factors may include any considerations relevant to the presentation of an advertisement including but not limited to: user preferences, user profiles, user interests, user location, bandwidth, advertisement position, seasonality, popularity, or page information. In one example, an advertisement may be displayed as text, as an image, or as video depending on one or more of the dynamic advertisement factors. Alternatively, the advertisement may be interactive and receive user input which affects its presentation. The dynamic presentation of advertisements may improve the effectiveness of the advertisement.

Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims. Nothing in this section should be taken as a limitation on those claims. Further aspects and advantages are discussed below in conjunction with the embodiments.

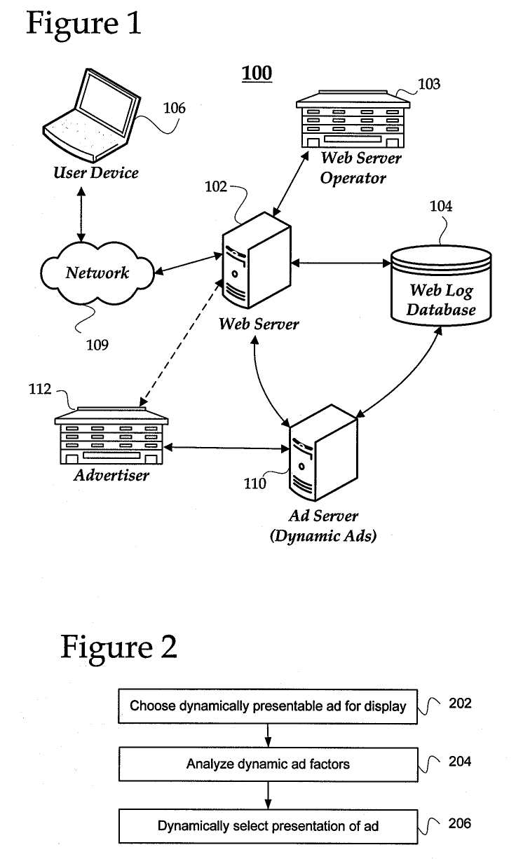

FIG. 1 depicts a block diagram illustrating one embodiment of an exemplary advertising system 100. The advertising system 100 may provide a platform for selection, optimization, and/or distribution of advertisements for inclusion in pages, such as web pages. In the advertising system 100, a user device 106 is coupled with a web server 102 through a network 109. The web server 102 is coupled with a web log database 104, and both are coupled with an ad server 110. An advertiser 112 may be coupled with the ad server 110 and/or the web server 102. Herein, the phrase “coupled with” is defined to mean directly connected to or indirectly connected through one or more intermediate components. Such intermediate components may include both hardware and software based components. Variations in the arrangement and type of the components may be made without departing from the spirit or scope of the claims as set forth herein. Additional, different or fewer components may be provided.

The user device 106 may be a computing device which allows a user to connect to a network 109, such as the Internet. Examples of a user device include, but are not limited to, a personal computer, personal digital assistant (“PDA”), cellular phone, or other electronic device. The user device 106 may be configured to allow a user to interact with the web server 102 or other components of the advertising system 100. The user device 106 may include a keyboard, keypad or a cursor control device, such as a mouse, or a joystick, touch screen display, remote control or any other device operative to allow a user to interact with the web server 102 via the user device 106. In one embodiment, the user device 106 is configured to receive information from the web server 102, such as a web page.

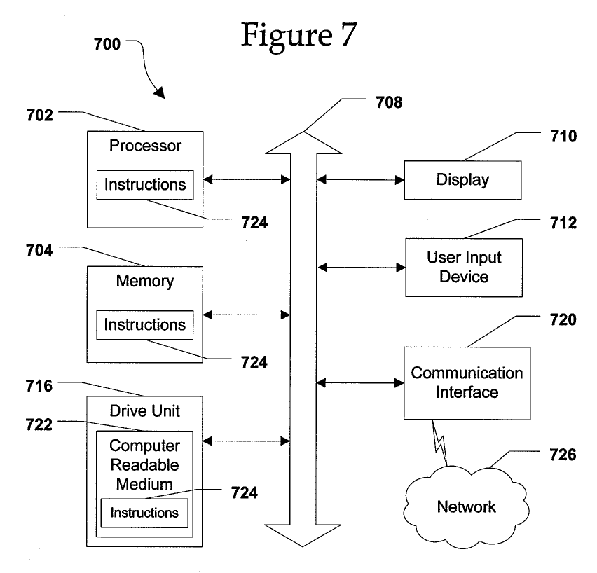

The user device 106 may be configured to access other data/information in addition to web pages over the network 109, such as the Internet, using a web browser, such as INTERNET EXPLORER® (sold by Microsoft Corp., Redmond, Wash.). The data displayed by the browser may include advertisements. In an alternative embodiment, software programs other than web browsers may also display advertisements received over the network 109 or from a different source. The user device 106 may be the user device described below with respect to FIG. 7.

In one embodiment, the web server 102 provides an interface to a network 109 and/or provides a web page to the user device 106. The web server 102 may provide the user device 106 with pages, including advertisements, that are requested by a user of the user device 106. In particular, the web server 102 may act as an interface to a larger network, such as the Internet and/or the network 109, by providing a portal for a user of the user device 106. The web server 102 may be a content provider for the user device 106 that provides content from another source, such as other web servers in a network. The web server 102 may be operated by a web server operator 103 that maintains and oversees the operation of the web server 102.

In one embodiment, the web server 102 may be a search engine for searching for pages, such as the web page which may be accessed on the World Wide Web at yahoo.com (operated by Yahoo! Inc., in Sunnyvale, Calif.), which is used to search for pages in a network. The user may input a search term (also referred to as a query or a keyword) into the user device 106 that is transmitted to the web server 102. A single search query may include multiple words or phrases. The web server 102 performs a search for the search query and provides the results of the search for display on the user device 106. The web server 102 may also display advertisements that are relevant to the search results and provided by the ad server 110 as discussed below.

The web server 102 may include or be coupled with a web log database 104. The web log database 104 may include records or logs of at least a subset of the queries or requests for data inputted in the web server 102 over a period of time. In one example, the web log database 104 may include a history of search terms or Internet browsing data. The data stored in the web log database 104 may relate to or include various user information, such as preferences, interests, profile information or browsing tendencies, and may include the dynamic advertisement factors discussed below. The web log database 104 may also receive its data from other sources, either internal or external. Other data may include other searching or web browsing tendencies identified by other web servers.

The ad server 110 may be coupled with the web server 102 and is configured to provide advertisements to be displayed on the user device 106 with the content provided by the web server 102. The advertiser 112 may be coupled with the web server 102 and/or the ad server 110 for providing its advertisements for display. The advertiser 112 may operate or oversee the ad server 110 by receiving advertisements and selecting advertisements for display on pages. In one embodiment, the advertiser 112 pays a fee each time the advertiser's advertisement is displayed, or each time the advertisement is clicked on. In one embodiment, the ad server 110 is coupled with a plurality of advertisers from which it receives a number of advertisements for display. The ad server 110 may compile and store the advertisements from the advertisers, and it may choose which advertisements are displayed. The advertisements that are displayed may be selected based on a variety of factors including targeting, relevance, popularity and/or price.

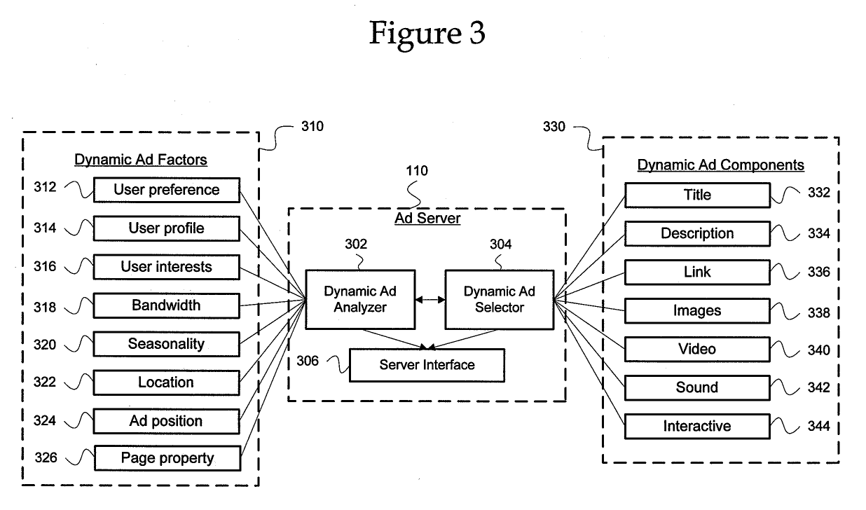

In one embodiment, the ad server 110 may receive advertisements in different forms as further described below with respect to FIGS. 2 and 3. For example, a single advertisement may include a number of advertising components that may or may not be present each time the advertisement is displayed. For example, a description, a video, an image, a sound, or interactive content may be ad components that may or may not be included each time the advertisement is displayed. In one embodiment, the ad server 110 dynamically displays the advertisement by selecting certain ad components, depending on dynamic ad factors. Accordingly, the ad server 110 is configured to dynamically display advertisements by displaying different forms of an advertisement to different users and user devices as described below with respect to FIGS. 2 and 3.

In one embodiment, when a user requests content for the user device 106, the request is submitted to the web server 102 over the network 109. The web server 102 retrieves the relevant content and contacts the ad server 110 to receive at least one advertisement to be displayed with the content. The ad server 110 may then select the form of the advertisement by selecting which advertisement components are displayed as part of the advertisement. The content with the advertisement may then be transmitted to the user device 106 and the user views the content as well as the advertisement. The web log database 104 may maintain records of requests for a particular user or include other user information that may be available to the ad server 110 to be used in selecting the advertisement to be displayed. In an alternative embodiment, the ad server 110 may be coupled with a separate database (not shown) including information relevant for selecting advertisements. In another embodiment, the web server 102 and the ad server 110 may be the same component and the web server operator 103 may be the advertiser 112. In that embodiment, all the functions performed by the ad server 110 are performed by the combined component.

Any of the components in the advertising system 100 may be coupled with one another through a network, including but not limited to the network 109, such as the Internet. For example, the ad server 110 may be coupled with the web server 102 or the web log database 204 over a network. Likewise, the advertiser 212 may be coupled with the web server 102 and/or the ad server 110 over a network. Accordingly, any of the components in the advertising system 100 may include communication ports configured to connect with a network. As described with respect to FIG. 3, the ad server 110 may include a server interface 306 which may operate as a communication port for transferring data to and from the web server 102, the advertiser 112, the web log database 104, and/or the user device 106.

The network or networks that may connect any of the components in the advertising system 100 to enable communication of data between the devices may include wired networks, wireless networks, or combinations thereof. The wireless network may be a cellular telephone network, a network operating according to a standardized protocol such as IEEE 802.11, 802.16, 802.20, published by the Institute of Electrical and Electronics Engineers, Inc., or WiMax network. Further, the network(s) may be a public network, such as the Internet, a private network, such as an intranet, or combinations thereof, and may utilize a variety of networking protocols now available or later developed including, but not limited to TCP/IP based networking protocols. The network(s) may include one or more of a local area network (LAN), a wide area network (WAN), a direct connection such as through a Universal Serial Bus (USB) port, and the like, and may include the set of interconnected networks that make up the Internet. The network(s) may include any communication method or employ any form of machine-readable media for communicating information from one device to another. For example, the ad server 110 or the web server 102 may provide advertisements and/or content to the user device 106 over a network, such as the network 109. The network or networks described above, including the network 109 may be the network discussed below with respect to FIG. 7.

The web server 102, the web log database 104, the advertisement server 110, the user device 106, the web server operator 103, and/or the advertiser 112 may represent computing devices of various kinds, such as the components described with respect to FIG. 7. Such computing devices may generally include any device that is configured to perform computation and that is capable of sending and receiving data communications by way of one or more wired and/or wireless communication interfaces. Such devices may be configured to communicate in accordance with any of a variety of network protocols, including but not limited to protocols within the Transmission Control Protocol/Internet Protocol (TCP/IP) protocol suite. For example, the user device 106 may be configured to execute a browser application that employs HTTP to request information, such as a web page, from the web server 102. The present disclosure contemplates a computer-readable medium that includes instructions or receives and executes instructions responsive to a propagated signal, so that any device connected to a network can communicate voice, video, audio, images or any other data over a network.

FIG. 2 is a flow chart illustrating one embodiment advertisement presentation. In block 202, a dynamically presentable advertisement (ad) is chosen for display. A user may request content from a web server 102, which receives an ad from the ad server 110. The ad may be dynamically presentable, which means that it may be displayed in multiple forms or with different ad components displayed depending on various factors as discussed below. In block 204, dynamic ad factors are analyzed to determine the dynamic presentation of the ad, as in block 206. As described below with respect to FIG. 3, there may be a number of dynamic ad factors that are considered in selecting the presentation of the ad.

FIG. 3 is a diagram illustrating an exemplary embodiment using dynamic advertisements. FIG. 3 illustrates an embodiment of the ad server 110. In particular, the ad server 110 may include a dynamic ad analyzer 302, a dynamic ad selector 304, and a server interface 306 coupled with one another. The server interface 306 may be a communication port configured to transmit and receive data to/from the web server 102, the advertiser 112, the web log database 104, and/or the user device 106.

The dynamic ad analyzer 302 may receive dynamic ad factors 310, which may be used to determine the most effective presentation of an advertisement by the dynamic ad selector 304. The dynamic ad selector 304 considers the analysis by the dynamic ad analyzer 302 of the dynamic ad factors 310 in selecting dynamic ad components 330 which may be included for display with the dynamic advertisement.

The dynamic ad components 330 include different features which a dynamic advertisement may or may not display. As discussed above, a dynamic advertisement may be presented in different forms, such as by including different features, such as the dynamic ad components 330. Advertisements may be presented or displayed differently on different pages, depending on the dynamic ad factors 310 as discussed below. The dynamic ad components 330 discussed herein are merely exemplary of the different features that may be modified with an advertisement and additional features and/or components are within the scope of this disclosure.

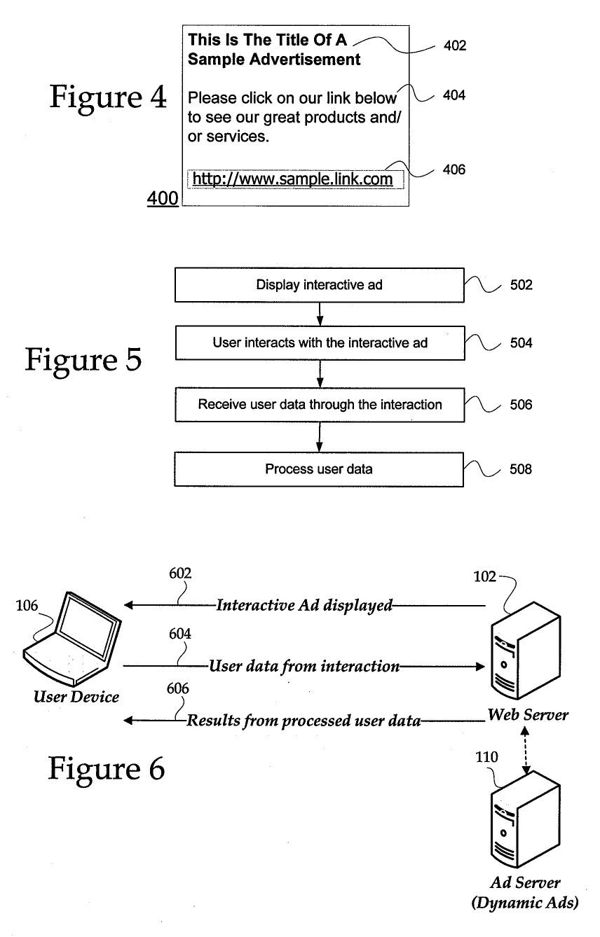

FIG. 4 illustrates an example of an advertisement 400. As shown, the title 402 illustrates the topic of the advertisement. In one embodiment, the title 402 may be the name of a product or service that is being advertised. Referring back to FIG. 3, the title 332 is an example of a dynamic ad component 330. The title 402 may be one example showing the title 332 as a dynamic ad component. Likewise, the description 404 may describe the product/service that is being advertised. The description 334 may also be a dynamic ad component 330. Finally, the link 406 may be a website or universal resource locator (URL) that links to a web page that is being advertised. The link 336 may also be a dynamic ad component 330. Accordingly, the sample advertisement 400 shown in FIG. 4 includes three dynamic ad components: the title 402, the description 404, and the link 406. FIG. 4 is illustrative of one sample dynamic advertisement 400 which includes the three dynamic components 330 of the title 332, the description 334, and the link 336. Additional examples of dynamic advertisements may include any combination of dynamic ad components 330.

FIG. 3 illustrates further examples of dynamic ad components 330. For example, an advertisement may include an image 338 that is displayed as part of the ad. The image may be of a logo, product, or anything else to draw the user's attention or enhance the advertisement. Accordingly, an advertisement may be displayed with an image 338 as one of its components. Likewise, a video 340 may be utilized as a dynamic ad component 330 for an advertisement. For example, an advertisement for a movie may display a video of the movie's trailer. Sound 342 may also be used as a dynamic ad component 330 for a particular advertisement. For example, a portion of a song may be played by an advertisement selling digital music.

An additional example of a dynamic ad component 330 may be an interactive component 344. An interactive component 344 of an advertisement may allow a user to interact with the advertisement. FIGS. 5 and 6 illustrate interactions with an interactive component 344 of an advertisement.

FIG. 5 is a flow chart illustrating an interaction with an advertisement. In block 502, an interactive advertisement is displayed to a user. Examples of interactive advertisements may include advertisements with the ability to fill in information on the advertisement, such as booking a table at a restaurant, booking travel, or car rental. Alternatively, the advertisement may provide driving direction for a map, or provide an alert to a mobile device based on user interaction. In block 504, the user interacts with the interactive ad. The interaction will vary depending on the interactive ad. For example, the user interaction may be filling in a form or providing other information about the user. In block 506, the user data is received from the user based on the interaction. In one embodiment, the web server 102 and/or the ad server 110 receives the user inputted data as a result of the interaction. In block 508, the user inputted data may be processed. In the case of booking a table at a restaurant, the user fills in information on the advertisement and that information is transmitted and used to reserve the table at the restaurant, as in block 508.

FIG. 6 is a diagram illustrating a further interaction with an advertisement. In particular, FIG. 6 illustrates a data transfer between the user device 106 and the web server 102 and/or the ad server 110. At line 602, the interactive advertisement is displayed on the user device 106. This may be the result of a request by a user of the user device 106 for certain content that is associated with the advertisement by the web server 102 and/or the ad server 110. The interactive ad is displayed on the user device 106 and may receive user data as a result of an interaction by a user of the user device 106 with the interactive advertisement as in line 604. As described in FIG. 5, the user data may be from a user submitting information through the interactive advertisement, or from clicking on or selecting options that are displayed in the interactive ad. As a result of the submitted user data, the web server 102 and/or the ad server 110 may provide results from the processed user data to the user device 106 as in line 606. The results may be directing the user to a different page that is relevant to the submitted user data, such as a table reservation confirmation.

Interactive ads may provide customized and relevant advertisements to the user that may encourage a direct response. Examples of interactive advertisements may include booking a rental car by typing in the zipcode, reserving a movie ticket by typing in the movie name and zipcode, etc. An interactive advertisement may improve the relevancy of the advertisement to the user and may encourage a response to the advertisement, which may result in better conversion rates for the advertiser and aids in better monetization for the publisher.

Referring back to FIG. 3, the dynamic ad factors 310 include considerations which may aid in choosing the presentation of an advertisement to make that advertisement more effective and appealing to a user. The dynamic ad factors 310 may be used to select which of the dynamic ad components 330 will be present in an advertisement. In one embodiment, the selected dynamic ad components 330 will establish the advertisement that is presented to the user. Alternatively, the dynamic ad components 330 may be sent to the user and the advertisement is dynamically displayed by selecting those components 330 at the user device. In particular, the dynamic ad analyzer 302 may use the dynamic ad factors 310 to allow the dynamic ad selector 304 to select the dynamic ad components 330 that are included in an advertisement.

User preference 312 is an example of a dynamic ad factor 310. A user may establish his/her preferences for viewing content and advertisements. For example, a user may not wish to view a video 340 or hear a sound 342 in advertisements. These user preferences may be transmitted from the user device 106 to the web server 102 and stored in the web log database 104 to be used when selecting the dynamic advertisement presentation. Accordingly, a user's preferences 312 may determine which dynamic ad components 330 are displayed in a particular advertisement.

User profile 314 is another example of a dynamic ad factor 310. The user profile 314 may include demographic information including age and sex. In one example, the video 340 ad component may be displayed only for users between the ages of 14 and 39 because they may be more technically savvy and more likely to watch a video. Likewise, the appearance of the advertisement may be modified for users over the age of 65. For example, the font of the title 332 and/or description 334 may be increased to improve visibility.

User interests 316 is another example of a dynamic ad factor 310. The user interests 316 may be provided by the user or may be based on past browsing history or purchasing history. A user who frequently views websites with downloadable video may be more likely to view advertisements that include video 340. The user interests 316 may be monitored or tracked by the web server 102 and stored in the web log database 104. In another example, a user who has provided information or historical data through interactive advertisements in the past may be shown more interactive advertisements in the future.

Bandwidth 318 is another example of a dynamic ad factor 310. A user who is receiving content and advertisements over a limited bandwidth, such as a dial-up connection with a 56K modem, may not receive ad components that require larger bandwidth, such as video 340. A low bandwidth user may receive advertisements that include only text to limit the amount of bandwidth that an advertisement uses. Conversely, users with a T3 or fiber optic network connection may receive any dynamic ad components 330 because bandwidth is not a limitation.

Seasonality 320 is another example of a dynamic ad factor 310. Seasonality 320 may refer to any time period, such as a season, month, day of the week, time of day, or other temporal time period. For example, when network traffic is highest around noon, it may be better to display certain ad components, such as an image designed to quickly get the attention of a user who may view multiple pages in a short amount of time. Likewise, users may spend more time on a page in the winter and less time in the summer, which may allow for additional ad components to be displayed when a user spends more time on a page. For a further discussion of seasonality and temporal targeting of advertisements, U.S. patent application Ser. No. 11/786,238, entitled “Temporal Targeting of Advertisements,” filed on Apr. 11, 2007, now U.S. Pat. No. ______ is hereby incorporated by reference.

Location 322 is another example of a dynamic ad factor 310. The geographic location of a user may result in the display of certain ad components. For example, users in the South may have images displayed that are catered to the lifestyle of the South. For example, a restaurant that advertises in the South may include an image of popular Southern dishes, but when advertising in the Midwest may display a different dish, or may not include an image at all in the advertisement, but just describe the restaurant in general.

Ad position 324 is another example of a dynamic ad factor 310. The location of an advertisement within a page may influence which components may be available for display. A small advertisement on the side of the page may not be large enough to display video; however, a large banner ad at the top of the page may be better suited for video.

Page properties 326 are another example of a dynamic ad factor 310. If a page already includes an audio stream, then the displayed advertisements should not include audio because that would interfere with the content of the page. Accordingly, the structure and content of the page may influence which ad components are displayed. The content, meta keywords, category, and structure of the page may be other page properties that influence the components of the dynamic ads.

As described above, the ad server 110 may include a dynamic ad analyzer 302 and a dynamic ad selector 304. The dynamic ad analyzer 302 may receive and analyze the dynamic ad factors 310 in order for the dynamic ad selector 304 to be able to select which dynamic ad components 330 are displayed. Accordingly, the dynamic ad components 330 that are selected and displayed may be determined, at least in part, by the dynamic ad factors 310. The examples of the dynamic ad factors 310 and dynamic ad components 330 described above are merely exemplary and may include additional examples within the scope of this disclosure.

In one example, the effectiveness of each of the ad components may be determined based on relevant dynamic ad factors. The relevancy of dynamic ad factors may be determined based on the content of a page or information provided by a user. The dynamic ad factors may be ranked or weighted to determine the most relevant factors which are used in selecting the ad components. In other words, not all dynamic ad factors may be relevant for every user and every page. The effectiveness of an ad component may be a measure of the likelihood a user views an ad (impression rate), clicks on an ad (click-through rate), performs an action based on or related to the advertisement (conversion), such as making a purchase or signing up for a service. Known relationships between the dynamic ad factors and the ad components may be established and stored. The stored relationships may be referenced in future cases to determine ad components to be displayed depending on the ad factors.

Referring to FIG. 7, an illustrative embodiment of a general computer system is shown and is designated 700. The computer system 700 can include a set of instructions that can be executed to cause the computer system 700 to perform any one or more of the methods or computer based functions disclosed herein. The computer system 700 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 700 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 700 can be implemented using electronic devices that provide voice, video or data communication. Further, while a single computer system 700 is illustrated, the term “system” shall also be taken to include any collection of systems or sub-systems that individually or jointly execute a set, or multiple sets, of instructions to perform one or more computer functions.

As illustrated in FIG. 7, the computer system 700 may include a processor 702, e.g., a central processing unit (CPU), a graphics processing unit (GPU), or both. The processor 702 may be a component in a variety of systems. For example, the processor 702 may be part of a standard personal computer or a workstation. The processor 702 may be one or more general processors, digital signal processors, application specific integrated circuits, field programmable gate arrays, servers, networks, digital circuits, analog circuits, combinations thereof, or other now known or later developed devices for analyzing and processing data. The processor 702 may implement a software program, such as code generated manually (i.e., programmed).

The computer system 700 may include a memory 704 that can communicate via a bus 708. The memory 704 may be a main memory, a static memory, or a dynamic memory. The memory 704 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one embodiment, the memory 704 includes a cache or random access memory for the processor 702. In alternative embodiments, the memory 704 is separate from the processor 702, such as a cache memory of a processor, the system memory, or other memory. The memory 704 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 704 is operable to store instructions executable by the processor 702. The functions, acts or tasks illustrated in the figures or described herein may be performed by the programmed processor 702 executing the instructions stored in the memory 704. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the computer system 700 may further include a display unit 714, such as a liquid crystal display (LCD), an organic light emitting diode (OLED), a flat panel display, a solid state display, a cathode ray tube (CRT), a projector, a printer or other now known or later developed display device for outputting determined information. The display 714 may act as an interface for the user to see the functioning of the processor 702, or specifically as an interface with the software stored in the memory 704 or in the drive unit 706.

Additionally, the computer system 700 may include an input device 716 configured to allow a user to interact with any of the components of system 700. The input device 716 may be a number pad, a keyboard, or a cursor control device, such as a mouse, or a joystick, touch screen display, remote control or any other device operative to interact with the system 700.

In a particular embodiment, as depicted in FIG. 7, the computer system 700 may also include a disk or optical drive unit 706. The disk drive unit 706 may include a computer-readable medium 710 in which one or more sets of instructions 712, e.g. software, can be embedded. Further, the instructions 712 may embody one or more of the methods or logic as described herein. In a particular embodiment, the instructions 712 may reside completely, or at least partially, within the memory 704 and/or within the processor 702 during execution by the computer system 700. The memory 704 and the processor 702 also may include computer-readable media as discussed above.

The present disclosure contemplates a computer-readable medium that includes instructions 712 or receives and executes instructions 712 responsive to a propagated signal, so that a device connected to a network 720 can communicate voice, video, audio, images or any other data over the network 720. Further, the instructions 712 may be transmitted or received over the network 720 via a communication port 718. The communication port 718 may be a part of the processor 702 or may be a separate component. The communication port 718 may be created in software or may be a physical connection in hardware. The communication port 718 is configured to connect with a network 720, external media, the display 714, or any other components in system 700, or combinations thereof. The connection with the network 720 may be a physical connection, such as a wired Ethernet connection or may be established wirelessly as discussed below. Likewise, the additional connections with other components of the system 700 may be physical connections or may be established wirelessly.

The network 720 may include wired networks, wireless networks, or combinations thereof. The wireless network may be a cellular telephone network, an 802.11, 802.16, 802.20, or WiMax network. Further, the network 720 may be a public network, such as the Internet, a private network, such as an intranet, or combinations thereof, and may utilize a variety of networking protocols now available or later developed including, but not limited to TCP/IP based networking protocols.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, and HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description. While various embodiments of the invention have been described, it will be apparent to those of ordinary skill in the art that many more embodiments and implementations are possible within the scope of the invention. Accordingly, the invention is not to be restricted except in light of the attached claims and their equivalents.

1. A method for presenting an advertisement on a web page comprising:
receiving a request for the web page from a computing device over a network;
selecting an advertisement to be displayed on the computing device in response to the request for the web page, wherein the selected advertisement is associated with a plurality of advertisement components, the advertisement components comprising a title, description, link, image, video, and sound, further wherein the advertisement includes any combination of the advertisement components;
receiving at least one dynamic advertisement factor related to displaying the selected advertisement;
selecting at least one advertisement component from the associated plurality of advertisement components, the selected at least one advertisement component to be displayed as part of the advertisement, wherein the selection of the at least one advertisement component is based on the at least one dynamic advertisement factor; and
transmitting the selected advertisement with the selected at least one advertisement component to the computing device, wherein each time the advertisement is transmitted, the at least one advertisement components that are displayed are selected based on the at least one dynamic advertisement factor.

2. The method according to claim 1 wherein the at least one dynamic advertisement factor is based at least in part on the user and are configured to influence the transmission of the selected advertisement.

3. The method according to claim 2 wherein the at least one dynamic advertisement factor comprises at least one of a preference of the user, a profile of the user, an interest of the user, a bandwidth of a connection by the user, or a location of the user.

4. The method according to claim 3 wherein the at least one dynamic advertisement factor further comprises at least one of seasonality, a position of the selected advertisement, or a property of a web page displaying the selected advertisement.

5. The method according to claim 1 wherein the selected advertisement comprises at least two of a title, a description, a link, an image, a video, audio, or user-interactive content.

6. The method according to claim 5 wherein the link comprises a hyperlink to a web page.

7. The method according to claim 1 further comprising receiving a request for the web page, wherein the web page includes content and at least one position configured for displaying an advertisement.

8. The method according to claim 7 wherein the transmission of the selected advertisements further comprises displaying the selected advertisement at one of the at least one position within the web page.

9. The method according to claim 1 wherein the selection of the at least one advertisement component further comprises:
determining which of the at least one dynamic advertisement factors are relevant;
determining an effectiveness for each of the ad components based on the relevant dynamic advertisement factors; and
selecting the ad components with a higher effectiveness.

10. The method according to claim 9 wherein the effectiveness is a measure of at least one of an impression rate, a click-through rate, or a conversion rate.

11. The method according to claim 9 wherein the determining of the relevant dynamic advertisement factors includes ranking the at least one dynamic advertisement factors.

12. In a computer readable storage medium having stored therein data representing instructions executable by a programmed processor for displaying an advertisement, the storage medium comprising instructions operative for:
displaying the advertisement on a web page, wherein the advertisement comprises advertisement components and the displayed advertisement includes at least one of the advertisement components, wherein the advertisement components comprise features that are displayed as part of the advertisement;
providing an interactive advertisement component with the displayed advertisement, wherein the interactive advertisement component is one of the advertisement components;
receiving user inputted data from a fillable form on the interactive advertisement component of the advertisement; and
processing the user inputted data.

13. The storage medium according to claim 12 wherein the processing the user inputted data comprises displaying a second web page including the user inputted data.

14. The storage medium according to claim 12 wherein the interaction with the interactive advertisement comprises at least one of a mouse click, a mouse point, or a typing.

15. The storage medium according to claim 12 wherein the processing the user inputted data further comprises transmitting the user inputted data to an advertiser, wherein the advertiser is a provider of the displayed advertisement.

16. The storage medium according to claim 12 wherein the advertisement components comprises at least one of a title, a description, a link, an image, a video, or audio, in addition to the interactive advertisement component.

17. The storage medium according to claim 16 wherein the advertisement components included with the displayed advertisement is based on at least one of a dynamic advertisement factor from a plurality of dynamic advertisement factors.

18. The storage medium according to claim 17 wherein the plurality of dynamic advertisement factors comprises at least one of a preference of the user, a profile of the user, an interest of the user, a bandwidth of a connection by the user, a location of the user, a seasonality, a position of the selected advertisement, or a property of a web page displaying the selected advertisement.

19. A system displaying an advertisement comprising:
a network;
a web server coupled with the network and configured to receive web page requests and provide web pages in response to the page requests; and
an advertisement server coupled with the web server by the network and configured to provide an advertisement on one of the web pages, wherein the advertisement comprises at least one advertisement component from a plurality of advertisement components, wherein the plurality of advertisement components associated with each advertisement comprises a title, description, link, image, video, sound, or interactive, the advertisement server comprising:
an analyzer configured to analyze dynamic advertisement factors;
a selector coupled with the analyzer and configured to select the at least one advertisement component from the plurality of advertisement components associated with the advertisement, wherein the selected advertisement component is included in the advertisement based on the analysis of at least one of the dynamic advertisement factors; and
an interface coupled with the selector and the web server and configured to provide the advertisement comprising the selected at least one advertisement component for display on the provided web page.

20. The system according to claim 19 further comprising:
a user device coupled with the web server over the network and configured to display the web page with the advertisement.

21. The system according to claim 20 wherein the advertisement for display is provided to the user device through the web server.

22. The system according to claim 19 wherein the plurality of dynamic advertisement factors comprises at least one of a preference of the user, a profile of the user, an interest of the user, a bandwidth of a connection by the user, a location of the user, a seasonality, a position of the selected advertisement, or a property of a web page displaying the selected advertisement.

23. The system according to claim 19 wherein the plurality of advertisement components comprises at least one of a title, a description, a link, an image, a video, audio, or user-interactive content.

24. A method for displaying an advertisement comprising:
receiving a request for a web page from a computing device, the web page including a position for the advertisement;
accessing a plurality of advertisements, wherein each advertisement includes a plurality of advertisement components, the advertisement components comprising a title, description, link, image, video, sound, and interactive;
choosing the advertisement from the plurality of advertisements to be displayed on the computing device in the position on the web page, wherein the choice is based on the web page request;
selecting, in response to the request for the web page, at least one of the plurality of advertisement components associated with the chosen advertisement to be displayed as part of the chosen advertisement; and
displaying the advertisement on the computing device including the selected at least one advertisement component on the web page wherein the selection of the at least one of the plurality of advertisement components is based at least in part on the request for the web page.
